(19) United States
(12) Patent Application Publication
(10) Pub. No.: US 2006/0157613 A1
(43) Pub. Date: Jul. 20, 2006

(54) Supersonic aircraft with active lift distribution control for reducing sonic boom

(76) Inventors: Eric E. Adamson, Seattle, WA (US); Chester P. Nelson, Seattle, WA (US)

Correspondence Address: PERKINS COIE LLP;PATENT-SEA, P.O. BOX 1247, SEATTLE, WA, 98111-1247, US

(21) Appl. No.: 11/039,651

(22) Filed: Jan. 19, 2005

(51) Int. Cl. B64C 1/40

(52) U.S. Cl. 244/1 N

(57) ABSTRACT

Methods and systems for actively reducing sonic boom in commercial supersonic aircraft and other supersonic aircraft are described herein. A method for operating an aircraft in accordance with one aspect of the invention includes configuring at least one lift control device to produce a first streamwise lift distribution, and flying the aircraft at a subsonic speed while the lift control device is configured to produce the first streamwise lift distribution. The method can further include configuring the lift control device to produce a second streamwise lift distribution, and flying the aircraft at a supersonic speed while the lift control device is configured to produce the second streamwise lift distribution. The first streamwise lift distribution produces an N-shaped ground pressure signature and a corresponding first sonic boom at the supersonic speed. The second streamwise lift distribution, however, produces a “shaped” ground pressure signature and a corresponding second sonic boom that is less than the first sonic boom at the supersonic speed.

### TECHNICAL FIELD

The following disclosure relates generally to supersonic aircraft and, more particularly, to methods for actively controlling the lift distribution of supersonic aircraft to reduce sonic boom.

### BACKGROUND

Current regulations prohibit any commercial supersonic flight over land. These regulations were formulated and promulgated at a time when supersonic aircraft caused sonic booms that were perceived by the public to be unacceptably loud. FIG. 1A is a plan view of a conventional supersonic aircraft 100 configured in accordance with the prior art. The aircraft 100 includes a wing 102 having a moderate leading edge sweep on the order of 55 degrees, a trailing edge sweep of about 0 degrees, and an aspect ratio (AR) of greater than 2. These wing parameters are balanced to provide the aircraft 100 with good performance characteristics in both supersonic cruise and during take-off and landing.

FIGS. 1B and 1C are graphs illustrating a streamwise lift distribution 104 and a corresponding ground pressure signature 110, respectively, for the prior art aircraft 100 during supersonic flight (e.g., at a cruise Mach number of 1.6 and an altitude of 50000 ft.). In FIG. 1B, longitudinal aircraft stations are measured along a horizontal axis 106, and cumulative lift is measured along a vertical axis 108. As this graph shows, the cumulative lift of the aircraft 100 increases dramatically between station 800 and station 1200. When propagated to the ground, the streamwise lift distribution 104 coalesces in the ground pressure signature 110 shown in FIG. 1C.

In FIG. 1C, time is measured along a horizontal axis 112 and pressure differential is measured along a vertical axis 114. As this graph illustrates, the ground pressure signature 110 of a conventional supersonic aircraft forms an N-wave with a substantial nose shock occurring at Tᵢ₁ and a corresponding tail shock occurring at T_{f1}. In the illustrated example, the nose shock has a magnitude of +1.2 pounds-per-square-foot (psf) and the tail shock has a magnitude of −1.2 psf.

Since the 1960s, it has been known that one way to reduce the perceived noise levels of a sonic boom is to “shape” the ground pressure signature so that the intensity of the nose and tail shocks are reduced. FIG. 2A, for example, is a plan view of a conventional low-boom supersonic aircraft 200 configured to produce a shaped ground pressure signature in accordance with the prior art. As is typical for such aircraft, the aircraft 200 has a thin wing 202 with highly swept leading and trailing edges. In the illustrated embodiment, for example, the wing 202 has a leading edge sweep of greater than 65 degrees, a trailing edge sweep of greater than 35 degrees, an AR of less than 2, and an airfoil thickness-to-chord ratio of less than four percent.

FIGS. 2B and 2C are graphs illustrating a streamwise lift distribution 204 and a corresponding ground pressure signature 210, respectively, for the prior art aircraft 200 during supersonic flight. As shown in FIG. 2B, the streamwise lift distribution 204 increases relatively gradually from station 800 to station 1600, as compared to the streamwise lift distribution 104 of the aircraft 100 discussed above with reference to FIG. 1A. This smoother and more gradual lift distribution results in the shaped ground pressure signature 210 illustrated in FIG. 2C. The ground pressure signature 210 is “shaped” in the sense that the nose shock of +0.5 psf occurring at Tᵢ₂ is substantially less than the nose shock of +1.2 psf occurring at Tᵢ₁ in FIG. 1C. In addition, after the initial nose shock at Tᵢ₂, the ground pressure signature 210 ramps up gradually to a positive peak before ramping down gradually to a negative trough. The tail shock of −0.5 psf occurring at time T_{f2} is also substantially less than the tail shock of −1.2 psf that occurs at time T_{f1}for the aircraft 100.

By reducing nose and tail shocks with wing sweep, commercial supersonic aircraft could, theoretically at least, achieve noise levels low enough to allow supersonic flight over land. Historically, however, these wing planforms have exhibited exceptionally poor stability and control characteristics at low speeds under take-off and landing conditions. In addition, these wing planforms also exacerbate the structural and aeroelastic/flutter problems inherent to most supersonic, thin-wing designs. The net result is that while the sonic boom requirements may be satisfied, the resulting aircraft becomes economically and technically impractical. Consequently, most supersonic design studies have concluded that the economic and operational penalties (e.g., reduced cruise L/D, increased structural weight, poor take-off performance, flutter/aeroelastic challenges, poor stability and control characteristics, etc.) associated with such a design far outweigh the potential economic benefits of reduced overland trip-time.

### SUMMARY

The following summary is provided for the benefit of the reader only, and does not limit the invention as set forth by the claims. The present invention is directed generally toward supersonic aircraft with active lift distribution control for reducing sonic boom. A method for operating an aircraft in accordance with one aspect of the invention includes flying the aircraft at a supersonic speed while the aircraft is in a first configuration. The method can further include changing the configuration of the aircraft from the first configuration to. a second configuration, and flying the aircraft at the supersonic speed while the aircraft is in the second configuration. In one embodiment, changing the configuration of the aircraft from the first configuration to the second configuration includes changing the streamwise lift distribution of the aircraft to shape the ground pressure signature. In this embodiment, the aircraft produces a first sonic boom when flying at the supersonic speed in the first configuration, and a second sonic boom that is less than the first sonic boom when flying at the supersonic speed in the second configuration.

A method for operating an aircraft in accordance with another aspect of the invention includes configuring at least one lift control device to produce a first streamwise lift distribution, and flying the aircraft at a subsonic speed while the lift control device is configured to produce the first streamwise lift distribution. The method can further include configuring the lift control device to produce a second streamwise lift distribution, and flying the aircraft at a supersonic speed while the lift control device is configured to produce the second streamwise lift distribution. At the supersonic speed, the first streamwise lift distribution can produce an N-shaped ground pressure signature and a corresponding first sonic boom, and the second streamwise lift distribution can produce a “shaped” ground pressure signature and a corresponding second sonic boom that is less than the first sonic boom. As a result, the aircraft can be flown over water at supersonic speeds while the lift control device is configured to produce the first streamwise lift distribution, and flown over land at supersonic speeds while the lift control device is configured to produce the second streamwise lift distribution.

### BRIEF DESCRIPTION OF THE DRAWINGS

FIG. 1A is a plan view of a conventional supersonic aircraft configured in accordance with the prior art, and FIGS. 1B and 1C illustrate a streamwise lift distribution and a ground pressure signature, respectively, for the supersonic aircraft of FIG. 1A.

FIG. 2A is a plan view of a conventional low-boom supersonic aircraft configured in accordance with the prior art, and FIGS. 2B and 2C illustrate a streamwise lift distribution and a shaped ground pressure signature, respectively, for the low-boom aircraft of FIG. 2A.

FIG. 3A is a partially schematic plan view of a supersonic aircraft having active lift distribution control for reducing sonic boom in accordance with an embodiment of the invention, and FIG. 3B is a graph illustrating two streamwise lift distributions for the supersonic aircraft of FIG. 3A.

FIGS. 4A-4E are end views of various aerodynamic control devices that can be used to actively control lift distribution in accordance with embodiments of the invention.

FIG. 5 is a table comparing flight mode to lift control mode in accordance with an embodiment of the invention.

FIGS. 6A-6H are isometric top views of various supersonic aircraft configurations having active lift distribution control for reducing sonic boom in accordance with embodiments of the invention.

### DETAILED DESCRIPTION

The following disclosure describes various methods and apparatuses for actively controlling the distribution of lift generated by supersonic aircraft to reduce sonic boom. Certain details are set forth in the following description to provide a thorough understanding of various embodiments of the invention. Other details describing well-known structures and systems often associated with supersonic aircraft are not set forth, however, to avoid unnecessarily obscuring the description of the various embodiments of the invention.

Many of the details, dimensions, angles, and other features shown in the Figures are merely illustrative of particular embodiments of the invention. Accordingly, other embodiments can have other details, dimensions, angles and features without departing from the spirit or scope of the present invention. Furthermore, additional embodiments of the invention can be practiced without several of the details described below.

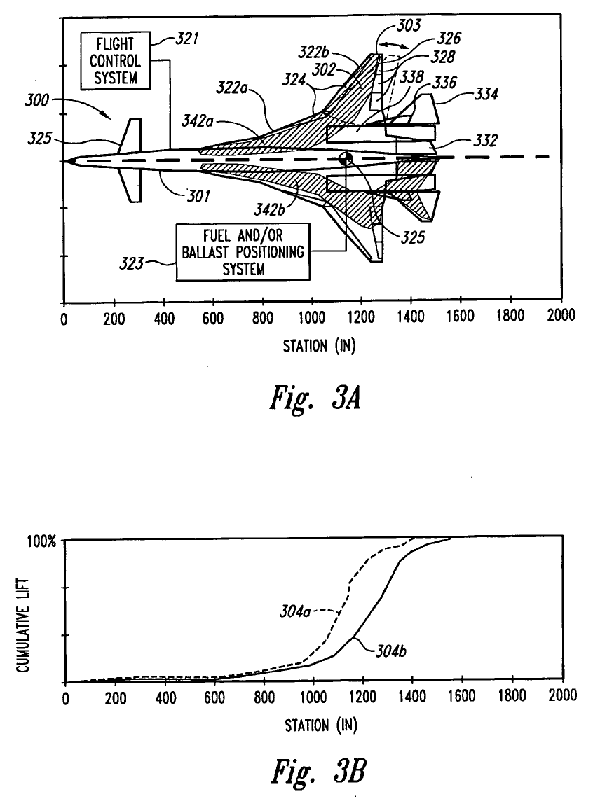

In the Figures, identical reference numbers identify identical or at least generally similar elements. To facilitate the discussion of any particular element, the most significant digit or digits of any reference number refer to the Figure in which that element is first introduced. For example, element 302 is first introduced and discussed with reference to FIG. 3.

FIG. 3A is a partially schematic plan view of a supersonic aircraft 300 configured in accordance with an embodiment of the invention, and FIG. 3B is a graph illustrating a first streamwise lift distribution 304a and a second streamwise lift distribution 304b for the aircraft 300. Referring first to FIG. 3A, the aircraft 300 includes a main wing 302 extending outwardly from an aft portion of a fuselage 301, and a forward wing or canard 325 extending outwardly from a forward portion of the fuselage 301. In the illustrated embodiment, the fuselage 301 is configured to carry a plurality of passengers. In other embodiments, however, the fuselage can be configured to carry other things including, for example, cargo, munitions, fuel, etc.

Two engine nacelles 338 provide thrust for the aircraft 301, and are positioned toward the aft portion of the fuselage 301. A vertical stabilizer 336 and a horizontal stabilizer 334 extend outwardly from each engine nacelle 338. An aft deck control surface 332 extends rearwardly between the engine nacelles 338.

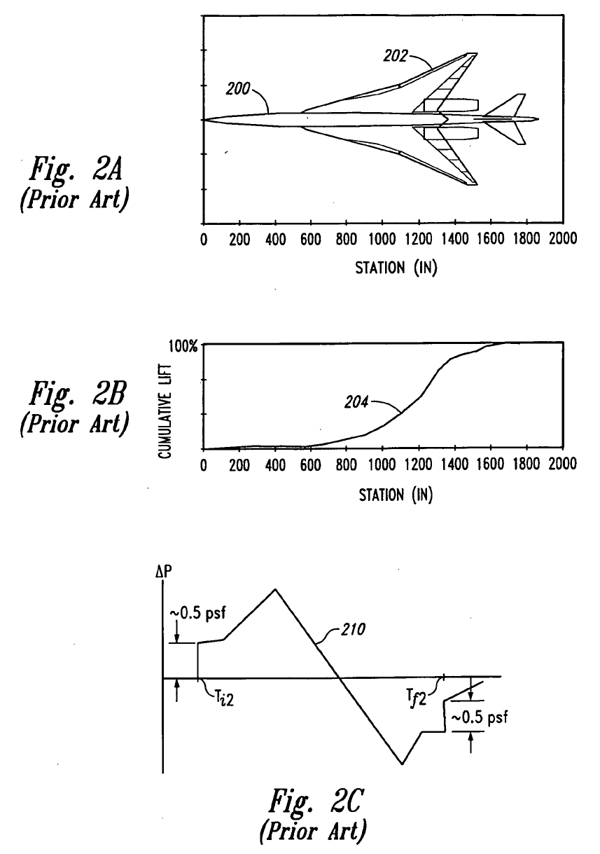

The wing 302 can include an inboard leading edge portion 322a, an outboard leading edge portion 322b, and a trailing edge portion 326. In the illustrated embodiment, the average sweep angle of the leading edge portions 322 is about 55 degrees, and the sweep angle of the trailing edge portion 326 is about 0 degrees. When compared to the conventional low-boom supersonic aircraft of FIG. 2A, the wing 302 has less sweep, a higher AR, and a greater airfoil thickness-to-chord ratio. As a result, the aircraft 300 can have better low speed performance, better stability characteristics, and less aerodynamic flutter concerns. In addition, the aircraft 300 can also have a lighter airframe.

In one aspect of this embodiment, the aircraft 300 includes a number of lift control devices that can be actively configured to change the streamwise lift distribution of the aircraft 300. These lift control devices can include, for example, leading edge control surfaces 324 (e.g., leading edge flaps), trailing edge control surfaces 328 (e.g., trailing edge flaps, ailerons, and/or elevons), the aft deck control surface 322, the horizontal stabilizer 334, and/or the canard 325. In addition to these lift control devices, an outboard wing portion 303 can be configured to pivot fore and aft relative to the fuselage 301, enabling the geometry or sweep of the wing 302 to be actively varied during flight.

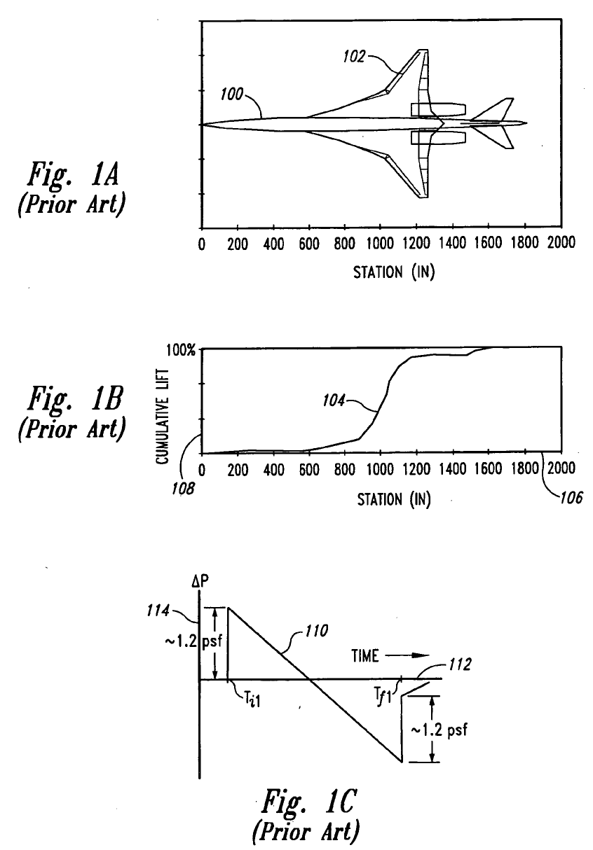

In another aspect of this embodiment, the aircraft 300 further includes a flight control system 321 (shown schematically in FIG. 3A) operably connected to one or more of the lift control devices described above. The flight control system 321 can be used to actively change the configuration of the lift control devices between a first configuration (e.g., a “high-boom” configuration) and a second configuration (e.g., a “low-boom” configuration). In the high-boom configuration shown in the top half of FIG. 3A, the various lift control devices can be configured to concentrate 90% of the total lift of the aircraft 300 in a first cross-hatched region 342a. This results in the first streamwise lift distribution 304a shown in FIG. 3B. The first streamwise lift distribution 304a offers the advantage of providing favorable low-speed flight characteristics in addition to favorable high-speed subsonic and supersonic performance. One disadvantage of the “high-boom” configuration, however, is that the first streamwise lift distribution 304a results in an N-wave ground pressure signature similar to the N-wave ground pressure signature 110 described above with reference to FIG. 1C. Consequently, the aircraft 300 would produce an unacceptably loud sonic boom if it were flown over land in this configuration at supersonic speeds.

In the “low-boom” configuration shown in the bottom half of FIG. 3A, the various lift control devices can be configured so that 90% of the total lift of the aircraft 300 is spread out over a second cross-hatched region 342b. This results in the second streamwise lift distribution 304b shown in FIG. 3B. Comparing the second streamwise lift distribution 304b to the first streamwise lift distribution 304a reveals that the second streamwise lift distribution 304b is more spread out and increases more gradually than the first streamwise lift distribution 304a. As a result, when the second streamwise lift distribution 304b propagates to the ground, it produces a “shaped” ground pressure signature similar to the shaped ground pressure signature 210 described above with reference to FIG. 2C. For a given weight, altitude, and Mach number, a shaped ground pressure signature causes less of a sonic boom than an N-wave ground pressure signature. Consequently, the aircraft 300 can be flown at supersonic speeds over land in the low-boom configuration without producing unacceptably loud sonic booms.

Changing the streamwise lift distribution of the aircraft 300 through active lift control can substantially alter the pitching moments or longitudinal “trim” of the aircraft 300. To compensate for this, the aircraft 300 can further include a fuel and/or ballast positioning system 323 (“positioning system 323”) operably connected to the flight control system 321. The positioning system 323 can be configured to move fuel (e.g., fuel in one or more fuselage tanks-not shown) and/or ballast (also not shown) either fore or aft in response to commands from the flight control system 321 to move a center of gravity 325 (CG 325). For example, if a particular streamwise lift distribution causes a positive (i.e., nose-up) pitching moment, the flight control system 321 can command the positioning system 323 to retrim the aircraft 300 by moving the CG 325 forward. Conversely, if the streamwise lift distribution causes a negative (i.e., nose-down) pitching moment, the flight control system 321 can command the positioning system 323 to retrim the aircraft 300 by moving the CG 325 aft.

One feature of the embodiment described above with reference to FIGS. 3A and 3B is that the flight control system 321 can actively change the streamwise lift distribution of the aircraft 300 depending on the particular flight mode. For example, the flight control system 321 can position the lift control devices in the high-boom configuration (top half of FIG. 3A) for high performance supersonic flight over water, or for subsonic flight (including take-off and landing). Alternatively, the flight control system 321 can position the lift control devices in the low-boom configuration (bottom half of FIG. 3A) for supersonic flight over land. One advantage of this feature is that it enables commercial aircraft to fly over land at supersonic speeds without creating unacceptably loud sonic booms (low-boom configuration), while at the same time enabling the aircraft to fly over water at supersonic speeds without performance compromises (high-boom configuration). A further advantage of this feature is it enables the aircraft to land in the high-boom configuration without the stability and control compromises typically found in conventional supersonic commercial aircraft.

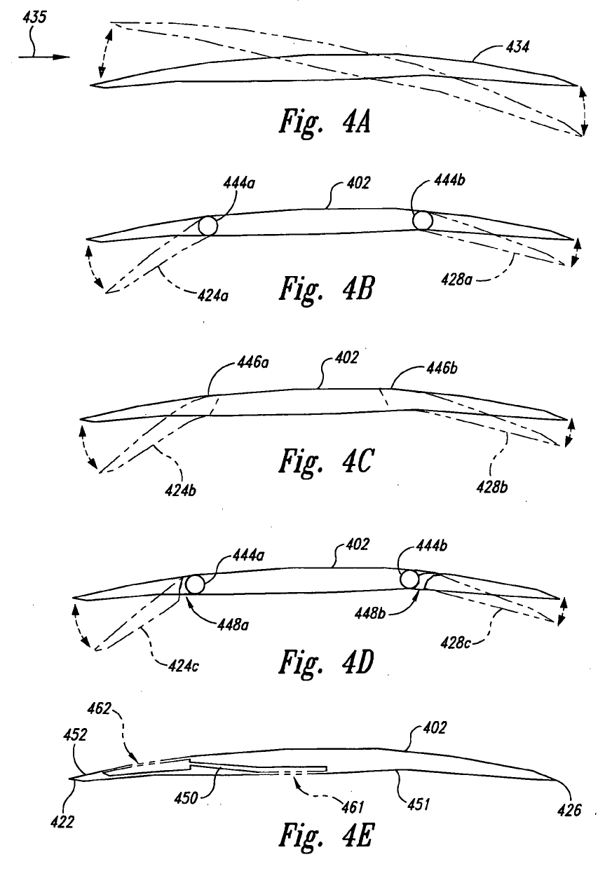

FIGS. 4A-4E are end views of various lift control devices that can be used to actively alter the streamwise lift distribution of the aircraft 300 of FIG. 3A. FIG. 4A, for example, illustrates a movable “slab” surface 434 that can be positioned at various angles-of-attack relative to a free stream 435. Various embodiments of the canard 325 and the horizontal stabilizer 334 of FIG. 3A can be at least generally similar in structure and function to the movable slab surface 434.

FIG. 4B is an end view of a wing 402 having a leading edge flap 424a and a trailing edge flap 428a. The leading edge flap 424a and the trailing edge flap 428a can pivot upwardly and/or downwardly about a first hinge 444a and a second hinge 444b, respectively, to alter the lift characteristics of the wing 402 as desired. In the illustrated embodiment, for example, the leading edge flap 424a and the trailing edge flap 428a are positioned in a low-boom mode in which the lift generated by the wing 402 is distributed toward a trailing edge portion 426.

FIG. 4C is an end view of the wing 402 having a leading edge flap 424b and a trailing edge flap 428b. The leading edge flap 424b and the trailing edge flap 428b are at least generally similar in structure and function to their counterparts shown in FIG. 4B. In the embodiment of FIG. 4C, however, the leading edge flap 424b and the trailing edge flap 428b are pivotally attached to the wing 402 by a first flexible coupling 446a and a second flexible coupling 446b.

FIG. 4D is an end view of the wing 402 having a “slotted” leading edge flap 424c and a slotted trailing edge flap 428c. The leading edge flap 424c and the trailing edge flap 428c are at least generally similar in structure and function to their counterparts described above with reference to FIGS. 4B and 4C. In the embodiment of FIG. 4D, however, the leading edge flap 424c is spaced apart from a corresponding first hinge 444a by a first gap 448a, and the trailing edge flap 428c is spaced apart from a second hinge 444b by a second gap 448b. Various embodiments of the leading edge control surfaces 324 and the trailing edge control surfaces 328 of FIG. 3A can be at least generally similar in structure and function to the leading edge flaps 424 and the trailing edge flaps 428, respectively, described above with reference to FIGS. 4B-4D.

FIG. 4E is an end view of the wing 402 having a passage 450 extending from an inlet 461 positioned on a lower surface 451 to an outlet 462 positioned on an upper surface 452. The outlet 462 can be positioned proximate to a wing leading edge portion 422. In low-boom mode, the passage 450 can be open so that high pressure air from the lower surface 451 flows to the upper surface 452, thereby reducing the amount of lift generated by the wing leading edge portion 422, and shifting the lift distribution aftward toward the trailing edge portion 426.

The various lift control devices discussed above with reference to FIGS. 3A-4E represent some of the different types of devices that can be employed to alter the streamwise lift distribution of the aircraft 300. In other embodiments, however, other lift control devices can be employed to suit a particular aircraft configuration, mission profile, etc. Such devices can include, for example, suction devices, blowing devices, microelectromechanical devices, plasma flow devices, and various surface-mounted active flow control devices.

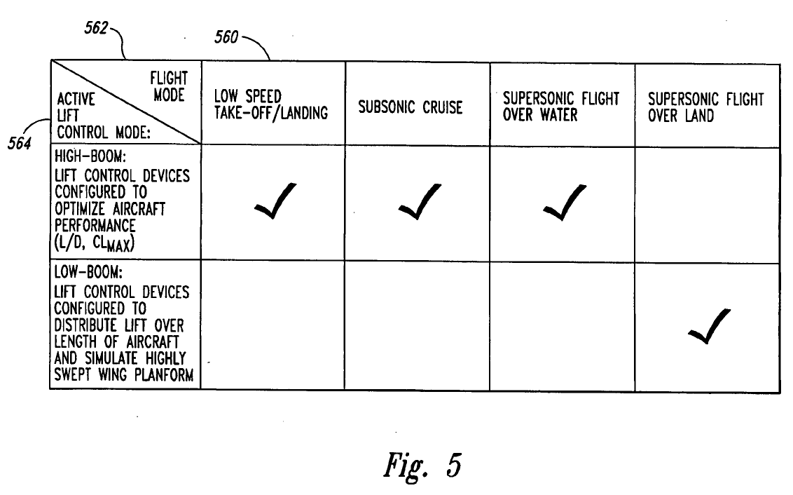

FIG. 5 illustrates a table 560 listing the appropriate lift control mode of the aircraft 300 (FIG. 3A) for various flight modes in accordance with an embodiment of the invention. The flight modes are listed across the top of table 560 in row 562, and the corresponding lift control modes are listed in column 564. As the table 560 shows, for low speed flight (e.g., during take-off and landing) the high-boom mode is selected. That is, the flight control system 321 configures the lift control devices to optimize aircraft performance (e.g., optimize L/D, CLₘₐₓ, etc). As the table 560 further shows, the high-boom mode is also selected for subsonic cruise and supersonic flight over water because sonic boom is not a concern in these flight modes and, therefore, performance should be optimized. The high-boom mode is not selected for supersonic flight over land, however, because sonic boom is a concern in this flight mode and the resulting sonic boom would be too loud. For supersonic flight over land, the low-boom mode is selected. That is, the flight control system 321 configures the lift control devices to distribute the lift smoothly over the length of the aircraft and simulate a highly swept wing planform. In this configuration, the aircraft 300 can fly over land at supersonic speeds without causing an unacceptably loud sonic boom.

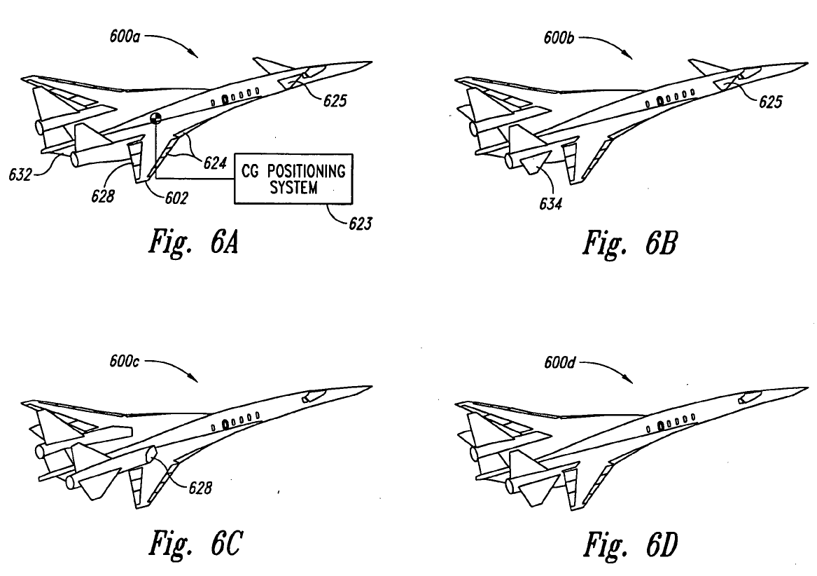

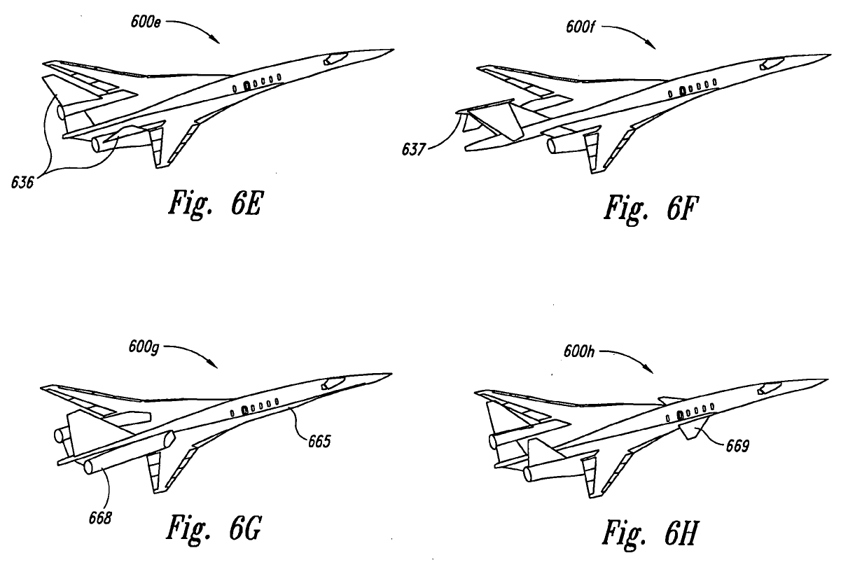

FIGS. 6A-6H are partially schematic, top isometric views of various aircraft configured in accordance with embodiments of the invention. FIG. 6A, for example, illustrates a supersonic aircraft 600a that is similar to the aircraft 300 described above with reference to FIG. 3A. The aircraft 600a includes a wing 602 having leading edge control surfaces 624 and trailing edge control surfaces 628. The aircraft 600a further includes a CG management system 623, a canard 625, and an aft deck control surface 632.

The configuration of the aircraft 600a offers a number of advantages for implementing the lift distribution control methods of the present invention. For example, the canard 625 allows a more aftward placement of the wing 602, thereby providing the aircraft 600a with a relatively long lifting length. Another advantage of this configuration is that the existence of three longitudinally-spaced lifting surfaces (i.e., the canard 625, the wing 602, and the aft deck control surface 632) enhances the ability to trim the aircraft 600a for a wider range of CG locations. Further, the additional lifting length provided by the aft deck surface 632 tends to lower sonic boom levels even when active lift control is not used. In addition, the continuity of lift provided by the contiguous aft deck surface 632 allows for smoother lift distribution and therefore smaller aerodynamic penalties when active lift control is employed to achieve lower sonic boom levels.

FIG. 6B illustrates a supersonic aircraft 600b that is at least generally similar in structure and function to the aircraft 600a. The aircraft 600b, however, further includes a horizontal stabilizer 634. FIG. 6C illustrates a supersonic aircraft 600c that is at least generally similar in structure and function to the aircraft 600b. The aircraft 600c, however, lacks the canard 625 and includes over-wing inlets 628. FIG. 6D illustrates a supersonic aircraft 600d that is at least generally similar to the aircraft 600b of FIG. 6B, except that the canard 625 has been omitted. FIG. 6E illustrates a supersonic aircraft 600e having a “V” tail; and FIG. 6F illustrates a supersonic aircraft 600f having an anhedral “T” tail 637. FIG. 6G illustrates a supersonic aircraft 600yg having over-wing inlets 668 and an extended strake 665. FIG. 6H illustrates a supersonic aircraft 600h having a strake-canard 669.

Although the various aircraft described above with reference to FIGS. 6A-6H illustrate some of the different configurations that can be utilized to implement the active lift distribution control methods described herein, those of ordinary skill in the art will recognize that various aspects of the present invention can be utilized with other aircraft configurations. Accordingly, the various configurations described above are merely illustrative of the various aircraft configurations that can be used to implement the methods and systems taught herein.

From the foregoing, it will be appreciated that specific embodiments of the invention have been described herein for purposes of illustration, but that various modifications may be made without deviating from the spirit and scope of the invention. For example, aspects of the invention described in the context of particular embodiments may be combined or eliminated in other embodiments. Further, while advantages associated with certain embodiments of the invention have been described in the context of those embodiments, other embodiments may also exhibit such advantages, and no embodiment need necessarily exhibit such advantages to fall within the scope of the invention. Accordingly, the invention is not limited, except as by the appended claims.

1. A method for operating an aircraft, the method comprising:
flying the aircraft at a supersonic speed while the aircraft is in a first configuration;
changing the configuration of the aircraft from the first configuration to a second configuration; and
flying the aircraft at the supersonic speed while the aircraft is in the second configuration, wherein the aircraft produces a first sonic boom having a first noise level when the aircraft is flying at the supersonic speed in the first configuration, and wherein the aircraft produces a second sonic boom having a second noise level that is less than the first noise level when the aircraft is flying at the supersonic speed in the second configuration.

2. The method of claim 1 wherein changing the configuration of the aircraft from the first configuration to the second configuration includes changing the streamwise lift distribution of the aircraft to shape the ground pressure signature of the aircraft.

3. The method of claim 1 wherein changing the configuration of the aircraft from the first configuration to the second configuration includes changing the streamwise lift distribution of the aircraft from a first streamwise lift distribution to a second streamwise lift distribution, wherein the second streamwise lift distribution increases more gradually over a length of the aircraft than the first streamwise lift distribution.

4. The method of claim 1 wherein changing the configuration of the aircraft from the first configuration to the second configuration includes moving a wing leading edge surface of the aircraft from a first position to a second position.

5. The method of claim 1 wherein changing the configuration of the aircraft from the first configuration to the second configuration includes moving a wing leading edge surface of the aircraft from a first position to a second position, and moving a wing trailing edge surface of the aircraft from a third position to a fourth position.

6. The method of claim 1 wherein changing the configuration of the aircraft from the first configuration to the second configuration includes moving a wing leading edge surface of the aircraft from a first position to a second position, moving a wing trailing edge surface of the aircraft from a third position to a fourth position, and moving an aft deck surface from a fifth position to a sixth position.

7. The method of claim 1 wherein changing the configuration of the aircraft from the first configuration to the second configuration includes moving a canard surface from a first position to a second position.

8. The method of claim 1 wherein changing the configuration of the aircraft from the first configuration to the second configuration includes moving a center of gravity of the aircraft from a first position to a second position.

9. The method of claim 1 wherein changing the configuration of the aircraft from the first configuration to the second configuration includes implementing an active flow control device on a wing of the aircraft.

10. The method of claim 1 wherein flying the aircraft at the supersonic speed while the aircraft is in the first configuration includes flying the aircraft over water while the aircraft is in the first configuration, and wherein flying the aircraft at the supersonic speed while the aircraft is in the second configuration includes flying the aircraft over land while the aircraft is in the second configuration.

11. A method for operating an aircraft, the method comprising:
configuring at least one lift control device to produce a first streamwise lift distribution of the aircraft, the first streamwise lift distribution producing a first ground pressure signature when the aircraft is flown at a supersonic speed, the first ground pressure signature producing a first sonic boom having a first noise level;
flying the aircraft at a subsonic speed while the lift control device is configured to produce the first streamwise lift distribution;
configuring the lift control device to produce a second streamwise lift distribution of the aircraft, the second streamwise lift distribution producing a second ground pressure signature when the aircraft is flown at the supersonic speed, the second ground pressure signature producing a second sonic boom having a second noise level that is less than the first noise level; and
flying the aircraft at a supersonic speed while the lift control device is configured to produce the second streamwise lift distribution.

12. The method of claim 11 wherein configuring at least one lift control device to produce a first streamwise lift distribution includes configuring the lift control device to produce an N-shaped ground pressure signature, and wherein configuring the lift control device to produce a second streamwise lift distribution includes configuring the lift control device to produce a shaped ground pressure signature.

13. The method of claim 11 wherein flying the aircraft at a supersonic speed while the lift control device is configured to produce the second streamwise lift distribution includes flying the aircraft over land at the supersonic speed, and wherein the method further comprises flying the aircraft over water at the supersonic speed while the lift control device is configured to produce the first streamwise lift distribution.

14. The method of claim 11 wherein configuring the at least one lift control device to produce the first streamwise lift distribution includes spreading the cumulative lift of the aircraft over a first distance, and wherein configuring the at least one lift control device to produce the second streamwise lift distribution includes spreading the lift of the aircraft over a second distance, the second distance being greater than the first distance.

15. The method of claim 11 wherein configuring the lift control device to produce a second streamwise lift distribution includes moving a wing leading edge surface from a first position to a second position.

16. The method of claim 11, further comprising moving a center of gravity of the aircraft from a first position to a second position after configuring the lift control device to produce a second streamwise lift distribution.

17. An aircraft comprising:
fuselage means;
means for producing a first streamwise lift distribution while the aircraft is flying at a supersonic speed, the first streamwise lift distribution producing an N-shaped ground pressure signature, the N-shaped ground pressure signature producing a first sonic boom having a first noise level; and
means for producing a second streamwise lift distribution while the aircraft is flying at the supersonic speed, the second steamwise lift distribution producing a shaped ground pressure signature, the shaped ground pressure signature producing a second sonic boom having a second noise level that is less than the first noise level of the first sonic boom.

18. The aircraft of claim 17 wherein the fuselage means include means for carrying a plurality of passengers.

19. The aircraft of claim 17 wherein the means for producing a second streamwise lift distribution include an aft deck control surface.

20. The aircraft of claim 17 wherein the means for producing a second streamwise lift distribution automatically produces the second streamwise lift distribution in response to a preselected flight speed.
